(19) United States
(12) Patent Application Publication
(10) Pub. No.: US 2012/0229639 A1
(43) Pub. Date: Sep. 13, 2012

(54) Truck Bed Monitoring System

(76) Inventor: Ronald Singleton, Iowa, LA (US)

(21) Appl. No.: 13/043,659

(22) Filed: Mar. 9, 2011

(51) Int. Cl. H04N 7/18

(52) U.S. Cl. 348/148; 348/E07.085

(57) ABSTRACT

A truck bed monitoring system comprising a monitor mounted within view of a user inside a cabin of a truck, and a camera built within a cargo light housing. The monitor includes a base to secure the monitor in place and a screen to observe an image. The camera includes a lens to view a truck bed wherein the camera sends the image recorded from the lens to the monitor to display the image on the screen; and wherein the camera enables the user to monitor how a hitch attached to the truck bed aligns with a trailer to ensure that the trailer and the hitch connect.

### BACKGROUND OF THE INVENTION

1. Field of the Invention

The present invention relates to a camera monitoring system wherein a camera is attached behind the cabin of a truck to record how the truck bed with a hitch connects to a trailer, and the recorded images are observed by a user on a monitor mounted within the truck cabin.

2. Description of Related Art

Hitching a trailer is a common procedure performed by many individuals owning or driving a variety of vehicles. Some trailers are hitched to a truck with a tow hitch attached to the chassis of the truck, traditionally referred to as bumper-pull hitches. These trailers may accommodate pulling a vehicle, a storage unit or even a boat. Alternatively, a gooseneck trailer is used when greater stability is needed when hitching the load. The gooseneck trailer utilizes a fifth wheel style of hitch which positions the trailer coupling ahead of the rear wheels. This style of hitch allows the supporting truck to pull more weight or a larger load attached to the trailer.

Many times difficulties are faced when a driver prepares to connect the gooseneck trailer to the truck bed supported hitch. Typically, when the driver is working alone they are dependent on their side and rearview mirrors to guide them. They must continuously check all mirrors to ensure that they are reversing to the correct location and at the correct angle to where the trailer coupling will attach to the hitch ball. Alternatively, the driver may have one or more other people to verbally direct how the driver reverses in order to connect the trailer. Even the slightest deviation may cause damage to a component of either the trailer or the hitch. When damages occur repairs are usually needed. The repairs may be simple enough to be handled by the driver or more complicated and only relieved by a professional. Ultimately, the damages may end up costing the driver the amount in repairs and any costs incurred by the delay.

It would be beneficial in the art to provide a more accurate system to monitor how a truck bed reversed to meet a trailer. It would also be desirable in the art for the system to allow a driver to operate it alone without the assistance of any other people.

### SUMMARY OF THE INVENTION

In view of the foregoing disadvantages inherent in the prior art, the purpose of the present disclosure is to provide a camera monitoring system wherein a camera is attached behind the cabin of a truck to record how the truck bed with a hitch connects to a trailer, and the recorded images are observed by a user on a monitor mounted within the truck cabin.

An object of the present invention is to provide a monitoring system for a driver to hitch a trailer without assistance by providing a camera to record the process and a monitor to display the camera's images.

Another object of the present invention is to provide a camera with adjustable lens view and focus, controlled by the monitor to enable the driver to change where the camera focuses for optimal guidance.

To achieve the above objects, in an aspect of the present invention, a truck bed monitoring system is disclosed comprising a monitor mounted within view of a user inside a cabin of a truck, and a camera built within a cargo light housing. The monitor includes a base to secure the monitor in place and a screen to observe an image. The camera includes a lens to view a truck bed wherein the camera sends the image recorded from the lens to the monitor to display the image on the screen; and wherein the camera enables the user to monitor how a hitch attached to the truck bed aligns with a trailer to ensure that the trailer and the hitch connect.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 depicts a perspective view of a truck bed monitoring system in accordance with an exemplary embodiment of the present invention.

### DETAILED DESCRIPTION OF THE DRAWINGS

The present invention relates to a camera monitoring system wherein a camera is attached behind the cabin of a truck to record how the truck bed with a hitch connects to a trailer, and the recorded images are observed by a user on a monitor mounted within the truck cabin. The present invention provides a truck bed monitoring system to simplify the process of hitching a gooseneck trailer. To use the truck bed monitoring system, the user simply watches the monitor screen within the truck bed while they back up to a trailer. The camera records the hitch, ball and the trailer so that the user never has to fumble with mirrors or rely on another person to align the truck. The camera may be adjusted with controls built onto the monitor so that the user is in continuous control of where the camera focuses. By providing an easier method of hitching a trailer the user's equipment may incur less damage from improper or misaligned guidance. Therefore the user's time is spent working more efficiently and more cost effectively.

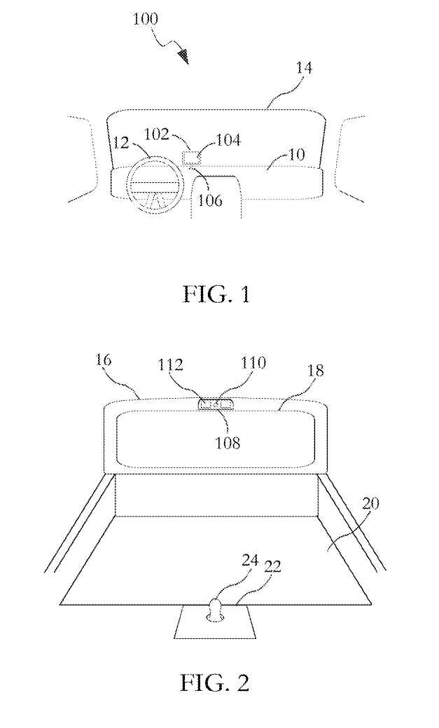

Tuning now descriptively to the drawings, referring to FIG. 1, a perspective view of a truck bed monitoring system (100) is shown in accordance with an exemplary embodiment of the present invention. The truck bed monitoring system (100) includes two main elements; a monitor (102) mounted within a truck cabin and a camera installed inside a cargo light housing (108). The monitor (102) includes a screen (104) to display the images recorded from the camera. The screen (104) may display black and white images or color images depending on the specifications of the camera used. Also, the screen (104) may display infrared illumination if the camera includes night vision capabilities.

A base (106) attached to a bottom portion of the monitor (102) is used to mount the monitor (102) within the truck cabin. The base (106) may elevate and secure the monitor (102) in place. The base (106) may include a ball socket connected to the monitor (102). The ball socket enables the monitor (102) to swivel, turn and redirect the screen (104) direction upon the base (106). The bottom of the base (106) may include a downward facing platform or suction cup that sticks to the dashboard (10) or the windshield (14). When the platform with a glued bottom is used, the base (106) may be permanently attached to the desired location therefore preventing dismounting or slippage of the base (106). Whereas when the suction cup is used, the base (106) may be repositioned at will by the user to alternate between various positions on the dashboard (10) and the windshield (14). The suction cup base may allow users of differing heights to utilize the monitor because what may be a preferred position to one user may not be to the other; therefore the suction cup allows the individual users to place the monitor to preferred location at will.

Positioning the monitor (102) is an important element of the truck bed monitoring system. The monitor (102) may be mounted to the dashboard (10) in front of the windshield (14). When mounted on the dashboard (10) the monitor (102) may be positioned near the steering wheel (12) to allow the monitor (102) to be continuously in view of a user. Likewise, the user may position the monitor (102) in the center of the windshield (14) or towards the steering wheel (12). Either way, the user does not have to look far from straight ahead to view the monitor (102), thereby enabling them to stay turned forward when using the truck bed monitoring system (100).

To power the monitor (102) a power source is built into the monitor (102) behind the screen (104). The power source may be a battery compartment to enable the monitor (102) to run on batteries. Alternatively, the power source may be the truck's engine, wherein a power cord connects the monitor (102) to the truck's cigarette lighter receptacle which powers the monitor (102) while the truck engine is on.

Turning focus to the truck bed (20), the cargo light housing (108) is positioned to a central upper portion of the cabin rear wall (16), above where the rear window (18) is installed. The camera of the truck bed monitoring system (100) may be housed within the cargo light housing (108) to eliminate any excess parts attached to the truck. The cargo light housing (108) includes a camera lens (110) centrally located between a pair of lights (112) (hereinafter lights). The lights (112) illuminate the truck bed (20) to provide a better viewing area for the camera. During use the camera records the truck bed (20) through the camera lens (110) and sends the images to the monitor (102) to project the images on the screen (104).

The monitor (102) may include a plurality of controls attached beside the screen (104). The plurality of controls may include power buttons, buttons to rotate the camera lens (110) and buttons to zoom and focus on the desired object the user wishes to observe on the screen (104). The user is then in constant control of the camera and is able to view all the parts of the truck bed (20), including where the truck bed ends, the hitch ((22) and the hitch ball (24). When the user prepares to hitch a gooseneck trailer they may easily switch focus between viewing the trailer coupling and the position of the hitch (22) and hitch ball (24). This way the truck bed (20) may be reversed while maintaining alignment between the hitch (22) and the trailer coupling. Continuous alignment may then prevent damages and any unnecessary costs caused by damages and delays. Along with the gooseneck trailer, the truck bed monitoring system (100) may also be used with a variety of other trailers. Finally, the truck bed monitoring system (100) may be used in a variety of circumstances when the user requires the need to monitor their rear components while maneuvering their vehicle in a reverse direction.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A truck bed monitoring system comprising:
a monitor mounted within view of a user inside a cabin of a truck, where said monitor includes:
a base to secure the monitor in place;
a screen to observe an image; and
a camera housed within a cargo light housing, wherein said camera includes a lens to view a truck bed;
wherein said camera sends said image recorded from said lens to said monitor to display said image on said screen; and
wherein said camera enables said user to monitor how a hitch attached to said truck bed aligns with a trailer to ensure that said trailer and said hitch connect.

2. The truck bed monitoring system according to claim 1, wherein said cargo light housing includes a pair of lights to illuminate said truck bed and enable better viewing for said camera.

3. The truck bed monitoring system according to claim 1, wherein said base is mounted to a dashboard.

4. The truck bed monitoring system according to claim 1, wherein said base is mounted to a windshield

5. The truck bed monitoring system according to claim 1, wherein said base includes a suction cup for removable attachment of said monitor.

6. The truck bed monitoring system according to claim 1, wherein said base includes a platform to permanently attach said monitor.

7. The truck bed monitoring system according to claim 1, wherein said monitor includes a plurality of controls to change where said camera lens focuses.

8. The truck bed monitoring system according to claim 7, wherein said plurality of controls includes a power button, a set of zoom buttons and a set of rotating buttons.

9. The truck bed monitoring system according to claim 1, wherein said screen displays color images.

10. The truck bed monitoring system according to claim 1, wherein said screen displays black and white images.

11. The truck bed monitoring system according to claim 1, wherein said camera includes night vision capabilities

12. The truck bed monitoring system according to claim 11, wherein said camera with night vision capabilities display infrared illuminated images on said screen.

13. The truck bed monitoring system according to claim 1, wherein said monitor includes a battery pack as a power source.

14. The truck bed monitoring system according to claim 1, wherein said monitor includes a power cord connected to a cigarette lighter receptacle as a power source.
